(19) United States
(12) Patent Application Publication
(10) Pub. No.: US 2004/0078457 A1
(43) Pub. Date: Apr. 22, 2004

(54) System and method for managing network-device configurations

(76) Inventor: Glen D. Tindal, Colorado Springs, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/274,785

(22) Filed: Oct. 21, 2002

(51) Int. Cl. G06F 15/173

(52) U.S. Cl. 709/223; 709/238

(57) ABSTRACT

A system and method for managing network-device configurations is described. In one exemplary embodiment, the present invention can include a central repository for storing configuration information about multiple network devices. This configuration information is organized for efficient searching and retrieval of relevant data. For example, network applications can search and retrieve relevant configuration information about particular network devices.

### FIELD OF THE INVENTION

The present invention relates to communication networks. In particular, but not by way of limitation, the present invention relates to systems and methods for managing network devices and network-device configurations.

### BACKGROUND OF THE INVENTION

Network devices, such as routers and switches, and their configurations are becoming increasingly more complicated. Network-device configurations were recently just a few hundred lines long. Present network-device configurations, however, tend to be thousands of lines long. Because network administrators can be responsible for thousands of network devices, the explosion in configuration length has compounded the difficulties with an already difficult job. For instance, a typical network administrator could be responsible for millions of lines of network-device-configuration code. This volume of configuration information is difficult to effectively manage, and, as importantly, it is difficult to effectively leverage with network-management applications.

Many network-device configurations leverage a format referred to as “command line interface” (CLI). Most Cisco™ routers, for example, use CLI. CLI-based-configurations commands are extremely cumbersome and lack standardization from manufacturer to manufacturer. To alleviate some of the problem with cumbersome device-specific formats, systems have been developed to transform these device-specific formats, e.g., CLI, to a more usable non-device-specific format such as XML. One example of such a system is described in U.S. application Ser. No. 09/942,833, entitled System and Method for Modeling a Network Device's Configuration, and in U.S. patent application Ser. No. 10/145,868, entitled System and Method for Transforming Configuration Commands, filed May 15, 2002. This transformation from device-specific format to XML or a non-device-specific format significantly increases the number of lines of configuration commands. For example, a thousand lines of CLI code equates to roughly five thousand lines of XML code. Assuming that a network includes five thousand devices and that each device could have five thousand lines of configuration commands, a typical network manager could be required to manage over twenty-five million lines of configuration commands. The organization of this high volume of commands is vital to the overall manageability of the network.

One method for organizing a repository of network-device-configuration commands involves a typical flat file. Thus, the configurations for thousands of network devices could be stored in a single flat file. This method is advantageous in that it is simple and requires little overhead. For larger networks, however, the flat-file method is cumbersome and limits a network administrator's ability to manage a network. For example, a network administrator would have great difficulty in leveraging, e.g., searching, a flat file with twenty-five million lines of configuration commands—calculated as five thousand lines per network device multiplied by five thousand network devices.

Accordingly, a system and method are needed for effectively storing and searching network-device configuration data. Additionally, a system and method are needed for efficiently utilizing network-device configuration data.

### SUMMARY OF THE INVENTION

The present invention can provide a system and method for managing networks and managing network-device configurations. In one exemplary embodiment, the present invention can include a central repository for storing configuration information about multiple network devices. This configuration information is organized for efficient searching and retrieval of relevant data. For example, network applications can search and retrieve relevant configuration information about particular network devices. Any retrieved configuration information can be used by a variety of network-management applications.

The above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a diagram of an organization for storing network-device-configuration data;

FIG. 2 is an alternate embodiment of an organization for storing network-device-configuration data;

FIG. 3 is a block diagram of a system constructed in accordance with the principles of the present invention;

FIG. 4 is a block diagram of one embodiment of the network manager shown in FIG. 3;

FIG. 5 is a flowchart of one method for managing a network using stored network-device-configuration data; and

FIG. 6 is a flowchart of an alternate embodiment of a method for managing a network device using configuration data.

### DETAILED DESCRIPTION

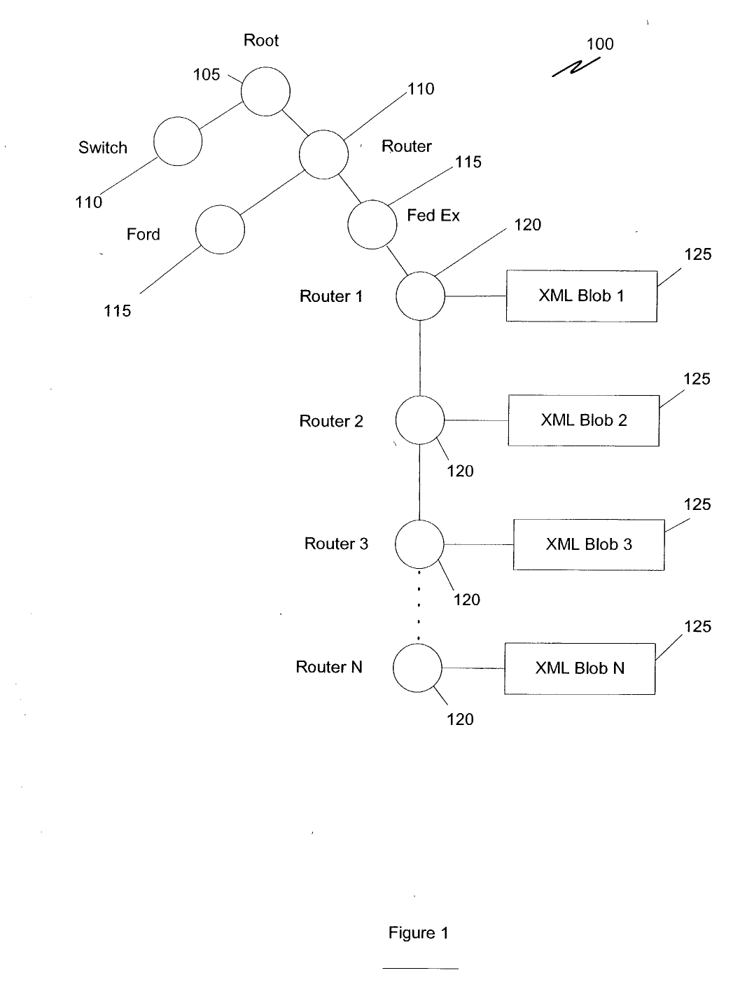

Referring now to FIG. 1, it is a diagram 100 of an organization for storing network-device-configuration data. This organization includes a directory structure such that network-device-configuration records can be specified by a particular path of nodes. For example, the path for “Router 2” would be “root/router/FedEx/Router 2.” Generically, a network device in this directory structure can be specified by the path “root/device type/realm/device name.” In other embodiments, a particular network device, e.g., a router or switch, could be specified by the path “root/realm/device name,” “root/realm/device type/device name,” “root/device type/realm/device group/device name,” etc.

The directory structure of FIG. 1 includes four levels—root 105, device type 110, realm 115, and device name 120. This structure is only exemplary. Additionally, the specific examples used to represent device type, realm and device name are only exemplary. For example, the device types are not limited to routers and switches. Other device types could include fabrics, optical devices, etc. Similarly, realms are not limited to enterprises. Realms could also include geographical categorizations, e.g., East coast and Midwest, and some combination of enterprises and geography.

The individual network devices are represented in level four of this directory structure. These devices are generally listed individually and are not necessarily dependent upon each other. By listing each device individually, this directory structure allows a path to a particular network device to be specified. For example, the path for “Router 2” is “root/router/FedEx/router 2.” Network applications can use this path to quickly access the configuration information for Router 2, which is contained in XML blob 2.

The XML blob 125 associated with each router—and more generally, with each network device—includes the configuration instructions, or representations thereof, for

that particular network device. In other embodiments, the configuration instructions can be in non-XML formats, including CLI. The XML blob 125 includes all or most of the configuration information for a particular network device, and as previously described, the XML blob 125 could include approximately five thousand lines of configuration code.

When a network application needs the value associated with a particular attribute of a particular router, the XML blob 125 for that router can be retrieved and each line therein searched. Thus, a simple data request could cause all five thousand lines of configuration data to be searched. For example, if a network application requested the value for the network access list used by Router 2, the entirety of XML blob 2 may need to be searched.

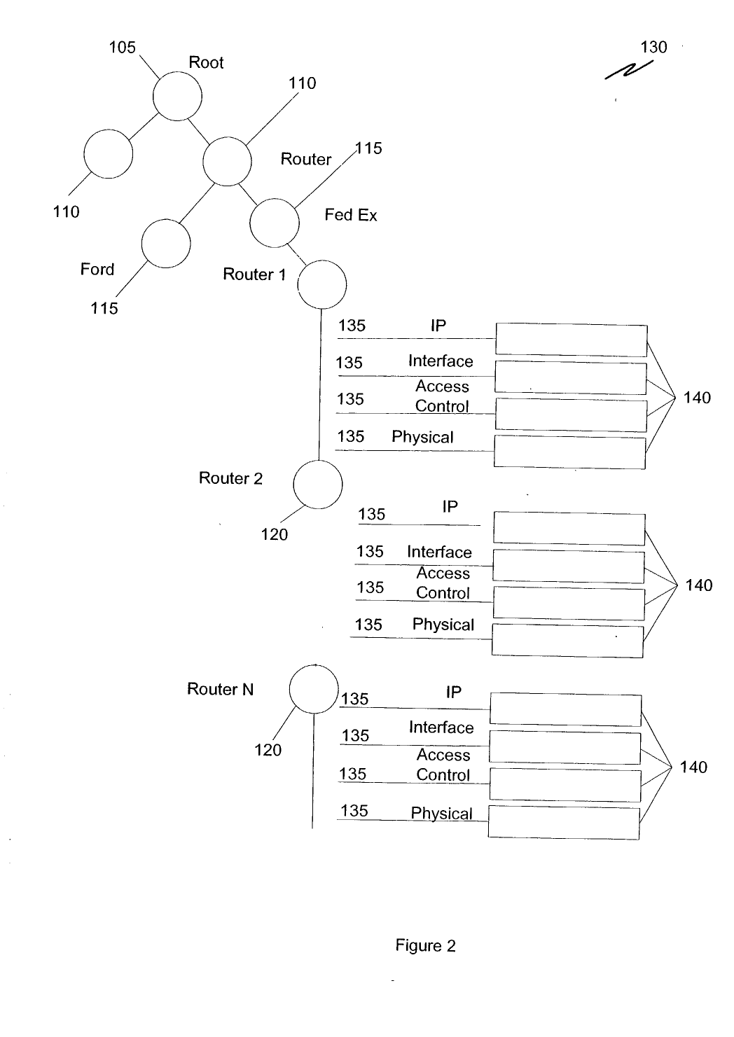

Referring now to FIG. 2, it is an alternate embodiment of an organization 130 for storing network-device-configuration data. This embodiment is similar to the embodiment shown in FIG. 1. For example, both embodiments include root 105, device type 110, realm 115, and device-name levels 120. The configuration shown in FIG. 2, however, segments the XML blob 125 of FIG. 1 into a plurality of nodes 135 and containers 140. Each node 135 represents a network-configuration principle, device characteristic, or other data grouping. For example, nodes 135 could indicate IP, Interfaces, Access Control, etc. Nodes 135 can also indicate divisions such as physical components, e.g., processors, cards, etc., and logical configurations. In one embodiment, the nodes 135 indicate reporting logs.

The node-container organization of FIG. 2, enables efficient searching of network-device configurations, including search methods that use lightweight directory access protocol (LDAP), directory access protocol (DAP), and X-path. The Interface node of Router 1, for example, can be defined as root/router/FedEx/Router 1/Interface—generically represented as root/device type/realm/device name/node. Network applications can use this type of path to quickly locate and retrieve relevant network-device configuration data without necessarily searching the entire configuration record. For example, a network application could request the access control list version being used by Router 2. The configuration data could then be searched to locate the container at root/router/FedEx/Router 2/Access Control. The value stored in the container could then be returned to the network application. Alternatively, the entire contents of the access control container could be returned to the network application. Notably, the containers 140 are not limited to storing single attributes or even multiple attributes. In one embodiment, the containers 140 include actual configuration commands associated with the node 135. For example, the IP node's container could include all commands relevant to routing protocols. The configuration commands included in the containers can be stored in a format that is native to the network device, e.g., CLI for a Cisco router, or in a generic format that can be translated into a device-native format.

The node-container model of FIG. 2 also enables efficient response to complex queries from network applications. For example, a network application may request the names of all routers that use Access Control List 100. In a flat-file system, such a request could cause millions of lines of configuration code to be searched. Using the node-container model, however, the network application could easily identify and search the Access Control containers, rather than the entire configuration, for each of the routers. For example, the search could retrieve the access control list from the path root/router/FedEx/***/Access Control, wherein *** is a wildcard indicating all routers on that path. If the network includes five thousand network devices, then the search would require looking at five thousand Access Control containers rather than millions of lines of configuration commands.

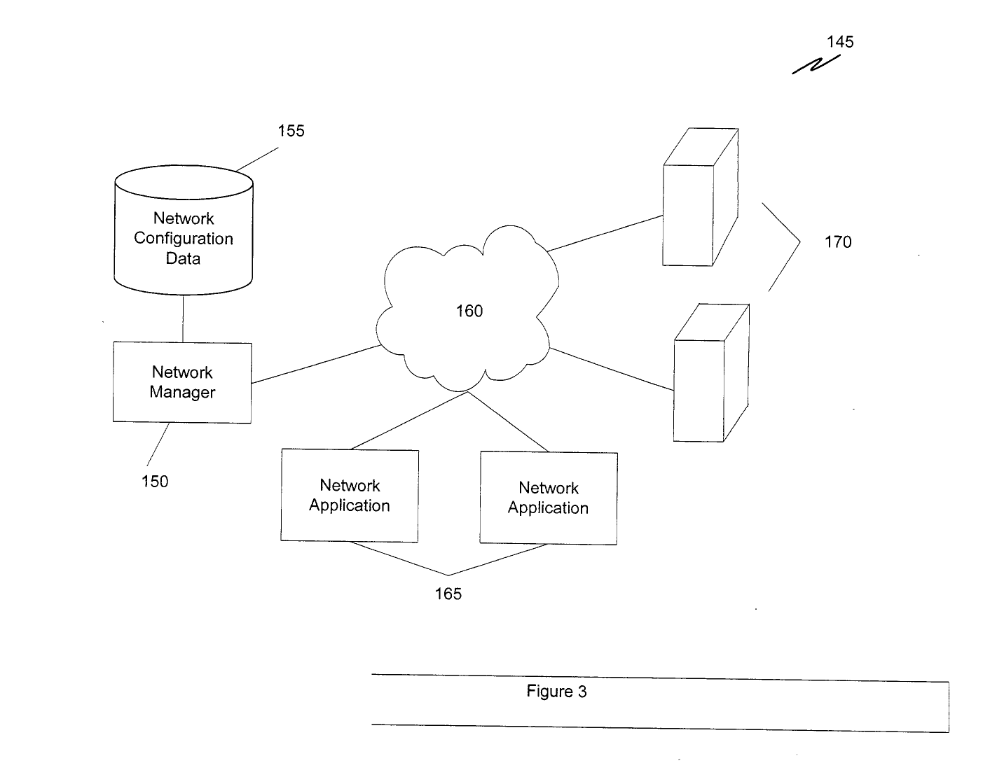

Referring now to FIG. 3, it is a block diagram of a system 145 constructed in accordance with the principles of the present invention. This embodiment of the present invention includes a network manager 150 connected to a network-configuration-data repository 155 and a network 160. Network applications 165 and network devices 170 are also connected to the network 160 such that they can communicate with the network manager 150.

The network-configuration data repository 155 (also referred to as the “repository”) is configured to store network-device-configuration information in a centralized location. The configuration information, however, need not be stored on a single storage device or even in one location. In one embodiment, the configuration information in the repository 155 is organized according to the previously described node-container configuration model, thereby enabling a network device 170 or application 165 to efficiently access the configuration information stored in the repository 155. The network manager 150 can broker the exchange between the network application 165 and the repository 155. For example, the network application 165 can provide a request or instruction to the network manager 150, and the network manager 150 can query the repository 155—possibly using LDAP. The network manager 150 can return attribute-value pairs, device identifiers, lists of device identifiers, and other data items to the network applications 165.

In one embodiment, the network manager 150 can also include integrated network applications. For example, the network manager 150 could initiate changes to network-device configurations and push those changes to the appropriate network devices 170. Additionally, the network manager 150 can update the repository 155 to reflect changes made to the configurations of the network devices 170; whether or not those changes were performed by the network manager 150.

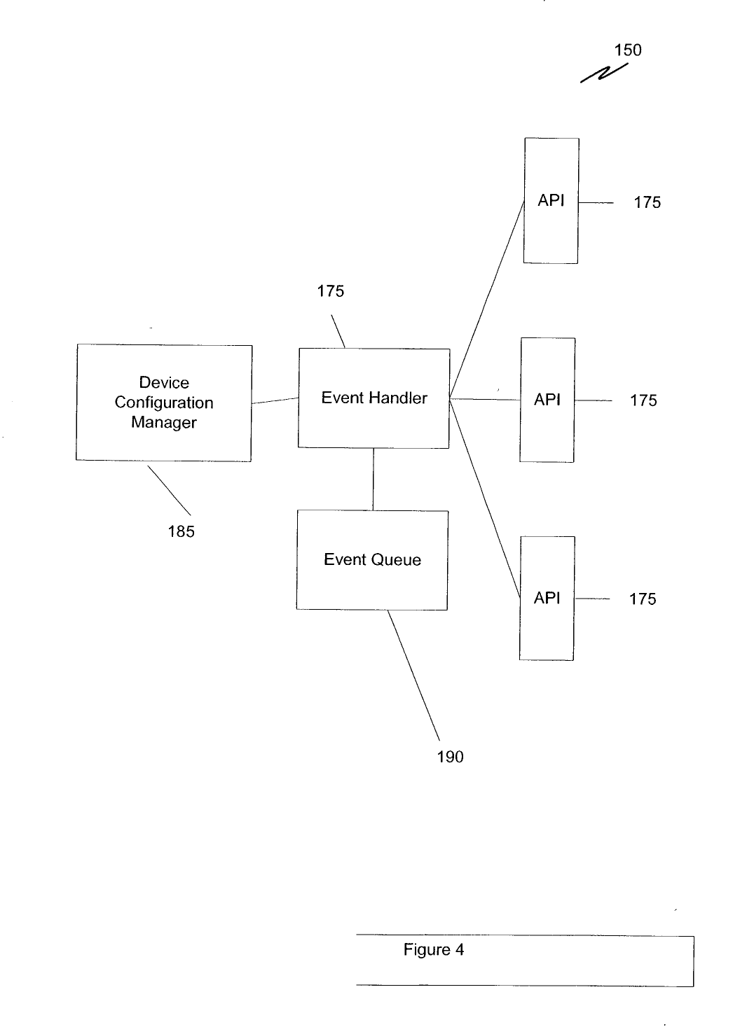

Referring now to FIG. 4, it is a block diagram of one embodiment of the network manager 150 shown in FIG. 3. Although this embodiment includes a number of components, the network manager 150 could be as simple as a query engine for the repository 155. The embodiment shown in FIG. 4, however, includes three application protocol interfaces (APIs) 175 connected to an event handler 180. The network applications 165 of FIG. 3 can communicate with the event handler 180 through one of the three APIs 175. Similarly, the event handler 180 can use the APIs 175 to communicate with the network applications 165, and network devices 170 can communicate directly to the event handler 180 through the APIs 175. For example, a network device 170 could send an error or report to the event handler 180 via one of the APIs. The APIs 175 provide for expandability of the network manager 150 but are not necessarily required.

The event handler 180 is configured to process communications received at the APIs 175. In one embodiment, the event handler 180 identifies the source of the communication and routes the communication accordingly. For example, if the received communication is from a network device 170 and the communication reports traffic conditions at the network device 170, then the event handler 180 could route that information to a log file in the repository 155—possible arranged as a node and container for that particular network device 170. Alternatively, if the communication from the network device 170 indicates an error, the communication can be immediately routed to the device configuration manager 185 for handling. For example, if the communication indicates that Router 1 has failed, then the device configuration manager 185 could determine the appropriate actions, e.g., page technical support, reroute traffic, etc., and act accordingly. In another embodiment, the event handler 180 can determine that an incoming communication is a request for future network configuration changes, e.g., modify the IP protocol on Router 1 at 4:00, and place that request in the event queue 190.

The network manager 150 is also configured to respond to information requests by network applications 175 or even network devices 170. For example, the network manager could search, or at least initiate a search, of the configuration data stored in the repository 155 shown in FIG. 3. As previously described, the search could involve a DAP or LDAP search.

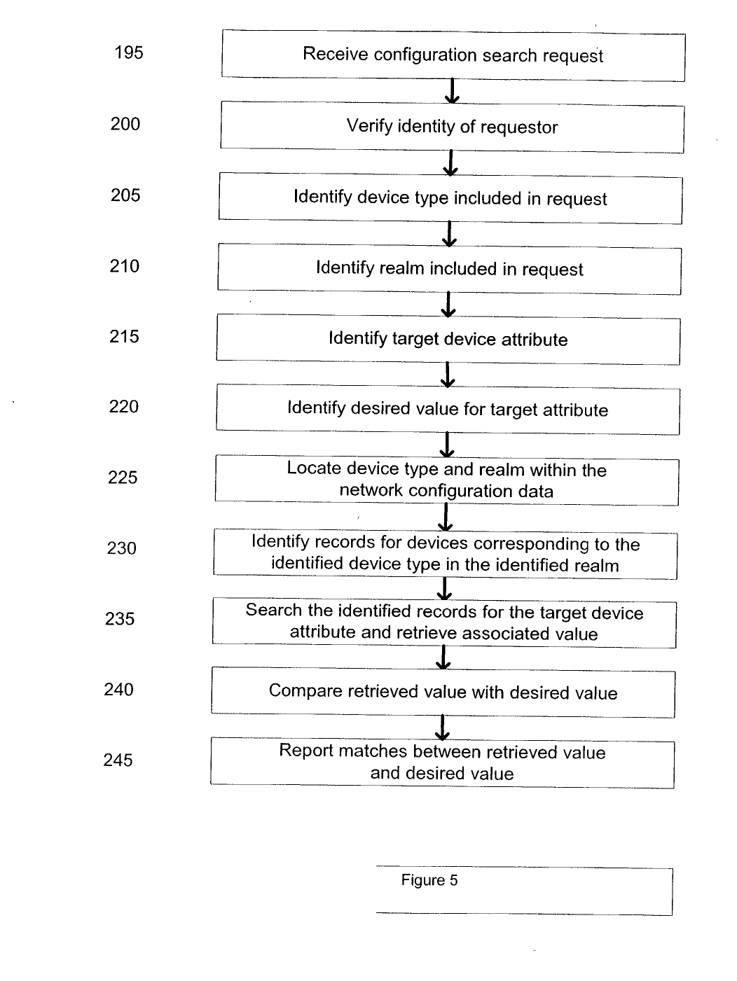

Referring now to FIG. 5, it is a flowchart of one method for managing a network using stored network-device-configuration data. This method is generally related to the container-node organization illustrated in FIG. 2 but can be modified to work with other container-node organizations and non-container-node organizations. Moreover, the method can be adapted for systems other than those illustrated in FIGS. 3 and 4.

In this method, the network manager, or some other device, receives a search request for network-configuration information Step 195. For example, the network manager could receive a communication from network application that requests a list of “all devices using Access Control List 100.” The network manager can verify the identity and permissions of the requestor, and assuming that the requestor is authorized to receive the requested information, the network manager can extract the device type, realm, target device attribute, and/or corresponding attribute from the request. Steps 200, 205, 210, 215 and 220. The network manager can transform the extracted information into a usable form if necessary. For example, if the device attribute indicated by the request does not match a defined node, e.g., Access Control, then the network manager can map the received device attribute to a defined node.

Using the information extracted from the received request, the network manager can identify the appropriate records, e.g., device, node, and containers. Step 225. The network manager could then compare the actual values, or configuration instructions, included in those containers against the desired attribute from the request. Steps 230, 235 and 240. For example, the network manager could search each Access Control container in the FedEx realm (path root/router/FedEx/***/Access Control) for “Access Control List 100.” Any matches could then be returned to the requesting network application. Step 245.

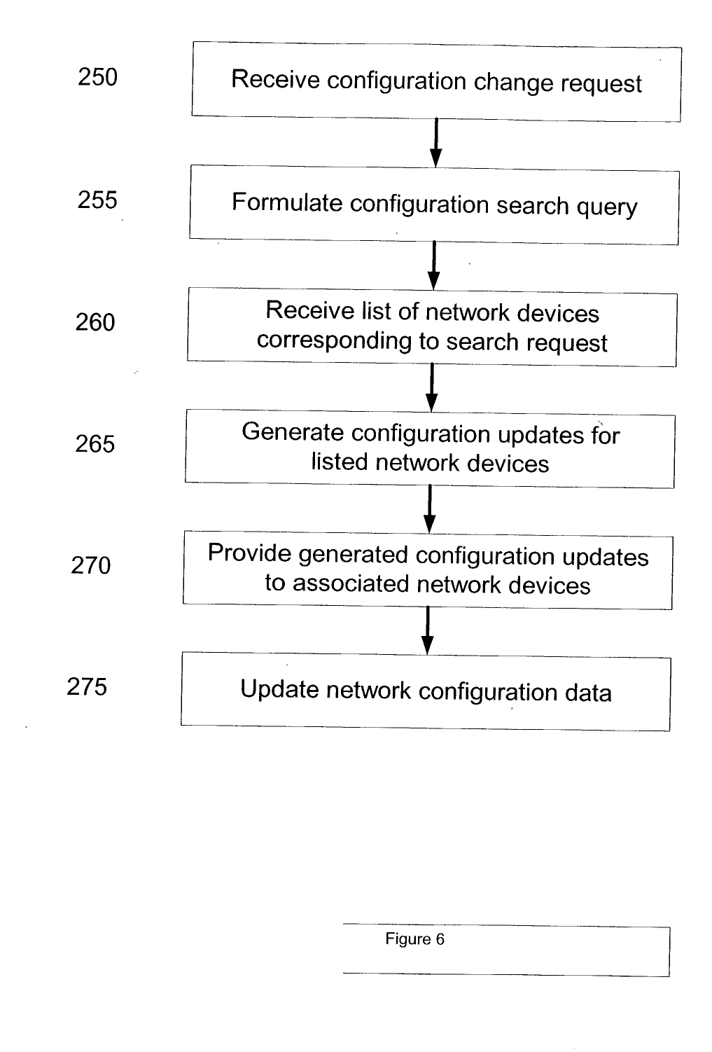

Referring now to FIG. 6, is a flowchart of an alternate embodiment of a method for managing a network device using configuration data. This method is generally related to the container-node organization illustrated in FIG. 2 but can be modified to work with other container-node organizations and non-container-node organizations. Moreover, the method can be adapted for systems other than those illustrated in FIGS. 3 and 4.

In this method, the network manager initially receives a configuration-change request. Step 250. This change request could originate from a network application or even an intelligent network device. A change request could be “change the access control list from version 100 to version 200 for all routers.” The network manager could formulate the query for the change request, submit the request to the repository (shown in FIG. 3), and receive the appropriate list of network devices. Steps 255 and 260. The network manager could return this list to the requesting network application or to another network application. Alternatively, the network manager could actually generate the update commands for the device included in the list and push those updates to the appropriate devices. Steps 265 and 270. Once the updates to the network devices have been completed, the repository can be updated. Step 275. For example, the network manager can write data to the Access Control container of the specified device as defined by the path root/router/realm/router 1/Access Control/list=200.

In conclusion, the present invention provides, among other things, a system and method for network management. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A system for managing network-device configurations, the system comprising:
a plurality of APIs configurable to communicate with corresponding ones of a plurality of network management applications;
a node-container-organized data repository for storing network-device-configuration data, wherein the network-device-configuration data is associated with a plurality of network devices; and
a network manager connected to the plurality of APIs and to the node-container-organized data repository, wherein the network manager is configurable to search the node-container-organized data repository responsive to a communication from one of the plurality of network management applications.

2. The system of claim 1, wherein the node-container-organized data repository comprises:
a plurality of configuration nodes that correspond to network-device characteristics.

3. The system of claim 2, wherein the network-device-configuration data comprises a plurality of network-device-configuration instructions and wherein each of the plurality of network-device-configuration instructions are storable in association with a corresponding configuration node.

4. The system of claim 2, wherein a first of the plurality of configuration nodes corresponds to routing protocols.

5. The system of claim 2, wherein a first of the plurality of configuration nodes corresponds to network device access control.

6. The system of claim 2, wherein a first of the plurality of configuration nodes corresponds to network device interfaces.

7. The system of claim 2, wherein a first of the plurality of configuration nodes corresponds to network device hardware configurations.

8. The system of claim 2, wherein the node-container-organized data repository comprises:
a plurality of configuration-value containers that correspond to the plurality of nodes, the configuration-value containers configured to include network-device-configuration values;
wherein the containers are identifiable using X-path.

9. The system of claim 2, wherein the node-container-organized data repository comprises:
a plurality of configuration-value containers that correspond to the plurality of nodes, the configuration-value containers configured to include network-device-configuration values;
wherein the containers are identifiable using LDAP.

10. The system of claim 1, wherein the network-device-configuration data is organizable according to network-device realms.

11. The system of claim 1, wherein the network-device-configuration data is organizable according to network-device types.

12. The system of claim 1, wherein the node-container-organized data repository is organized according to at least device type, realm, network-device-characteristic node and configuration-value container.

13. A system for storing network-device-configuration data, the system comprising:
computer-readable medium; and
plurality of configuration instructions stored on the computer-readable medium, the plurality of configuration instructions corresponding to a plurality of network devices;
wherein the plurality of configuration instructions are arranged according to a node-container organization.

14. The system of claim 13, wherein the plurality of configuration instructions are arranged according to realm and network-device characteristic.

15. The system of claim 13, wherein the plurality of configuration instructions are arranged according to network-device characteristic.

16. The system of claim 14, wherein the network-device characteristic comprises routing protocols.

17. The system of claim 14, wherein the network-device characteristic comprises network-device interfaces.

18. The system of claim 14, wherein the network-device characteristic comprises access control.

19. The system of claim 14, wherein the network-device characteristic comprises network-device-hardware configurations.

20. The system of claim 14, wherein the plurality of configuration instructions are represented in an XML format.

21. The system of claim 14, wherein the plurality of configuration instructions are represented in a CLI format.

22. The system of claim 14, wherein the plurality of configuration instructions are represented in a network-device-neutral format.

23. A method for managing network-device configurations, the method comprising:
receiving a request from a network application for network-device-configuration information;
determining a realm corresponding to the received request;
identifying a network device corresponding to the received request;
determining a network-device-characteristic corresponding to the received request;
retrieving the network-device-configuration container corresponding to the determined characteristic and the identified network device; and
providing at least a portion of the network-device-configuration container to the network application.

24. The method of claim 23, wherein retrieving the network-device configuration container comprises:
searching a repository of network-device-configuration information using LDAP.

25. The method of claim 23, wherein retrieving the network-device configuration container comprises:
searching a repository of network-device-configuration information using DAP.

26. The method of claim 23, wherein retrieving the network-device-configuration container comprises:
searching a repository of network-device-configuration information through X-path.

27. A method for managing network-device configurations, the method comprising:
receiving a request for network-device-configuration information;
identifying a plurality of network devices corresponding to the received request;
determining a network-device characteristic corresponding to the received request;
identifying a network-device-configuration-characteristic node corresponding to the determined network-device characteristic;
retrieving data from a network-device-configuration container corresponding to the identified network-device-configuration-characteristic node; and
providing at least an indicator of the retrieved data in response to the request.
